(19) United States
(12) Patent Application Publication
(10) Pub. No.: US 2016/0322139 A1
(43) Pub. Date: Nov. 3, 2016

(54) SOFT MAGNETIC COMPOSITE POWDER AND COMPONENT

(71) Applicant: HÖGANÄS AB (PUBL), Höganäs (SE)

(72) Inventors: Zhou YE, Lerberget (SE); Oskar LARSSON, Hägersten (SE)

(73) Assignee: HÖGANÄS AB (PUBL), Höganäs (DE)

(21) Appl. No.: 15/105,777

(22) PCT Filed: Dec. 18, 2014
(86) PCT No.: PCT/EP2014/078414

§ 371 Date: Jun. 17, 2016

(30) Foreign Application Priority Data
Dec. 20, 2013 (EP) 13198905.5

(51) Int. Cl. H01F 1/24; B22F 1/02; C22C 38/00; C22C 38/16; C22C 38/12; C22C 38/02; H01F 1/26; B22F 3/02

(52) U.S. Cl. CPC H01F 1/24; H01F 1/26; B22F 1/02; B22F 3/02; C22C 38/16; C22C 38/12; C22C 38/02; C22C 38/002; B22F 2301/35; B22F 2302/45; B22F 2003/023; B22F 2003/248

(57) ABSTRACT

The present invention concerns a composite iron-based powder mix suitable for soft magnetic applications such as inductor cores. The present invention also concerns a method for producing a soft magnetic component and the component produced by the method.

### FIELD OF THE INVENTION

The present invention concerns a soft magnetic composite powder material for the preparation of soft magnetic components as well as the soft magnetic components which are obtained by using this soft magnetic composite powder. Specifically the invention concerns such powders for the preparation of soft magnetic components materials working at high frequencies, the components suitable as inductors or reactors for power electronics.

### BACKGROUND OF THE INVENTION

Soft magnetic materials are used for various applications, such as core materials in inductors, stators and rotors for electrical machines, actuators, sensors and transformer cores. Traditionally, soft magnetic cores, such as rotors and stators in electric machines, are made of stacked steel laminates. Soft magnetic composites may be based on soft magnetic particles, usually iron-based, with an electrically insulating coating on each particle. By compacting the insulated particles optionally together with lubricants and/or binders using the traditionally powder metallurgy process, soft magnetic components may be obtained. By using the powder metallurgical technique it is possible to produce such components with a higher degree of freedom in the design, than by using the steel laminates as the components can carry a three dimensional magnetic flux and as three dimensional shapes can be obtained by the compaction process.

Ferromagnetic- or iron-core inductors use a magnetic core made of a ferromagnetic or ferrimagnetic material such as iron or ferrite to increase the inductance of a coil by several thousand by increasing the magnetic field, due to the higher permeability of the core material.

The magnetic permeability, μ, of a material is an indication of its ability to carry a magnetic flux or its ability to become magnetised. Magnetic permeability does not only depend on material carrying the magnetic flux but also on the applied electric field and the frequency thereof. In technical systems it is often referred to the maximum relative, measured during one cycle of the varying electrical field.

An inductor core may be used in power electronic systems for filtering unwanted signals such as various harmonics. In order to function efficiently an inductor core for such application shall have a low maximum relative permeability which implies that the relative permeability will have a more linear characteristic relative to the applied electric field, i.e. stable incremental permeability, μ_{Δ} (as defined according to ΔB=μ_{Δ}*ΔH), and high saturation flux density. In addition, low maximum relative permeability and stable incremental permeability combined with high saturation flux density enables the inductor to carry a higher electrical current. This is beneficial when size is a limiting factor as a smaller inductor can be used.

It is desirable to reduce the core loss characteristics of soft magnetic components. When a magnetic material is exposed to a varying field, energy losses occur due to both hysteresis losses and eddy current losses. The hysteresis loss is proportional to the frequency of the alternating magnetic fields, whereas the eddy current loss is proportional to the square of the frequency. Thus at high frequencies the eddy current loss matters mostly and it is especially required to reduce the eddy current loss and still maintaining a low level of hysteresis losses. This implies that it is desired to increase the resistivity of magnetic cores.

Various solutions for improving the resistivity have been proposed. One solution is based on providing electrically insulating coatings or films on the powder particles before these particles are subjected to compaction. Publications concerning inorganic coatings are e.g. U.S. Pat. No. 6,309,748, U.S. Pat. No. 6,348,265 and U.S. Pat. No. 6,562,458. Coatings of organic materials are disclosed in U.S. Pat. No. 5,595,609. Coatings comprising both inorganic and organic material are disclosed in U.S. Pat. No. 6,372,348 and U.S. Pat. No. 5,063,011, and DE3,439,397, according to which publication the particles are surrounded by an iron phosphate layer and a thermoplastic material. EP1246209B1 describes a ferromagnetic metal based powder wherein the surface of the metal-based powder is coated with a coating consisting of silicone resin and fine particles of clay minerals having layered structure such as bentonite or talc.

The patent application JP2002170707A describes an alloyed iron particle coated with a phosphorous containing layer, wherein the alloying elements may be silicon, nickel or aluminium

In order to obtain high performance soft magnetic composite components it must also be possible to subject the electrically insulated powder to compression moulding at high pressures as it is often desired to obtain parts having high density. High densities normally improve the magnetic properties. High densities are specifically needed in order to keep the hysteresis losses at a low level and to obtain high saturation flux density. Additionally, the electrical insulation must withstand the compaction pressures needed without being damaged when the compacted part is ejected from the die. This in turn means that the ejection forces must not be too high.

Furthermore, in order to reduce the hysteresis losses, stress releasing heat treatment of the compacted part may be required. In order to obtain an effective stress release the heat treatment should preferably be performed at a temperature above 300° C. and below a temperature where the insulating coating will be damaged, in an atmosphere of for example nitrogen, argon or air, or in vacuum.

The present invention has been done in view of the need for powder cores which are primarily intended for use at higher frequencies, i.e. frequencies above 2 kHz and particularly between 5 and 100 kHz, where higher resistivity and lower core losses are essential. Preferably, the saturation flux density shall be high enough for core downsizing. Additionally it should be possible to produce the cores without having to compact the metal powder using die wall lubrication and/or elevated temperatures.

In contrast to many used and proposed methods, in which low core losses are desired, it is an especial advantage of the present invention that it is not necessary to use any organic binding agent in the powder composition, which powder composition is later compacted in the compaction step. Heat treatment of the green compact can therefore be performed at higher temperature without the risk that any organic binding agent decomposes; a higher heat treatment temperature will also improve the flux density and decrease core losses. The absence of organic material in the final, heat treated core also allows the core to be used in environments with elevated temperatures without risking decreased strength due to softening and decomposition of an organic binder, and improved temperature stability is thus achieved.

### SUMMARY OF THE INVENTION

The inventors have shown that by mixing a previously known iron based powder with nano-crystalline and/or amorphous material, also in the form of a powder, a powder composition, or mixture, is obtained which can be used for manufacturing soft magnetic components having excellent magnetic characteristics.

The invention provides a powder mixture, comprising an atomized iron based powder and an amorphous and/or a nano-crystalline powder, wherein the powder particles are coated by a first phosphorous containing layer and a second layer containing a combination of alkaline silicate and clay particles containing defined phyllosilicates. Alternatively, said second layer is composed of a metal-organic compound. The amorphous and/or nano-crystalline powder may also be coated by said layers. According to one embodiment, the coating is constituted of the above two layers alone.

The invention also provides a method for producing an inductor core comprising the steps of:
a) providing a powder mixture as above,
b) compacting the powder mixture, optionally mixed with a lubricant, in a uniaxial press movement in a die at a compaction pressure between 400 and 1200 MPa
c) ejecting the compacted component from the die.
d) heat treating the ejected component at a temperature between 500° C. to 700° C.
A component, such as an inductor core, produced according to above.

### DETAILED DESCRIPTION OF THE INVENTION

The term “nano” is intended to define a size which is smaller than 0.1 μm in at least one dimension.

The nanocrystalline material contains particles having at least one dimension smaller than 100 nanometres and are composed of atoms in either a single- or poly-crystalline arrangement. These so-called nano-crystalline particles may be produced by rapid solidification from the liquid using a process such as melt spinning.

The present invention provides a mixture comprising or containing atomized iron based powder particles and iron-, nickel-, or cobalt based amorphous and/or nano-crystalline particles, wherein said particles are coated with a phosphorous containing layer.

The amorphous and/or nano-crystalline particles may be iron-, nickel-, or cobalt based and may be atomized or from milled melt-spun ribbons. The nano-crystalline structure may be achieved by tempering of the amorphous material prior to mixing and pressing or during heat treatment of pressed component.

If it is desirable to use completely amorphous powder, the tempering temperature should be less than the glass transition temperature for the chosen material. It is well within the capacity of the skilled person to determine the glass transition temperature, e.g. by using calorimetric analysis.

In addition, the particles may be coated by an “alkaline silicate-coating”, or “clay-coating” layer, containing an alkaline silicate combined with a clay mineral containing a phyllosilicate, wherein the combined silicon-oxygen tetrahedral layer and hydroxide octahedral layers thereof preferably are electrically neutral. This alkaline silicate-coating may be e.g. kaolin- or talc-based. The particles may, alternatively be coated by a metal-organic compound as defined below.

Throughout the text, the terms “layer” and “coating” may be used interchangeably.

The iron based powder particles may be water atomized or gas atomized. Methods for atomizing iron are known in the literature.

The iron based powder particles may be in the form of a pure iron powder having low content of contaminants such as carbon or oxygen. The iron content is preferably above 99.0% by weight, however it may also be possible to utilise iron-powder alloyed with for example silicon. For a pure iron powder, or for an iron-based powder alloyed with intentionally added alloying elements, the powders contain besides iron and possible present alloying elements, trace elements resulting from inevitable impurities caused by the method of production. Trace elements are present in such a small amount that they do not (or only marginally) influence the properties of the material. Examples of trace elements may be carbon up to 0.1%, oxygen up to 0.3%, sulphur and phosphorous up to 0.3% each and manganese up to 0.3%.

The particle size of the iron-based powder is chosen, based on the intended use, i.e. which frequency the component is suited for. The mean particle size of the iron-based powder, which is also the mean size of the coated powder as the coating is very thin, may be between 20 to 300 μm. Examples of mean particle sizes for suitable iron-based powders are e.g. 20-80 μm, a so called 200 mesh powder, 70-130 μm, a 100 mesh powder, or 130-250 μm, a 40 mesh powder.

The phosphorous containing coating which is normally applied to the bare iron-based powder may be applied according to the methods described in U.S. Pat. No. 6,348,265. This means that the iron or iron-based powder is mixed with phosphoric acid dissolved in a solvent such as acetone followed by drying in order to obtain a thin phosphorous and oxygen containing coating on the powder. The amount of added solution depends inter alia on the particle size of the powder; however the amount shall be sufficient in order to obtain a coating having a thickness between 20 and 300 nm.

Alternatively, it would be possible to add a thin phosphorous containing coating by mixing an iron-based powder with a solution of ammonium phosphate dissolved in water or using other combinations of phosphorous containing substances and other solvents. The resulting phosphorous containing coating cause an increase in the phosphorous content of the iron-based powder of between 0.01 to 0.15%.

The alkaline silicate coating is applied to the phosphorous coated iron-based powder by mixing the powder with particles of a clay or a mixture of clays containing defined phyllosilicate and a water soluble alkaline silicate, commonly known as water glass, followed by a drying step at a temperature between 20-250° C. or in vacuum. Phyllosilicates constitutes the type of silicates where the silicontetrahedrons are connected with each other in the form of layers having the formula (Si₂O₅²)ₙ. These layers are combined with at least one octahedral hydroxide layer forming a combined structure. The octahedral layers may for example contain either aluminium or magnesium hydroxides or a combination thereof. Silicon in the silicontetrahedral layer may be partly replaced by other atoms. These combined layered structures may be electroneutral or electrically charged, depending on which atoms are present. It has been noticed that the type of phyllosilicate is of vital importance in order to fulfil the objects of the present invention. Thus, the phyllosilicate shall be of the type having uncharged or electroneutral layers of the combined silicontetrahedral- and hydroxide octahedral-layer. Examples of such phyllosilicates are kaolinite present in the clay kaolin, pyrofyllit present in phyllite, or the magnesium containing mineral talc. The mean particle size of the clays containing defined phyllosilicates shall be below 15, preferably below 10, preferably below 5 μm, even more preferable below 3 μm. The amount of clay containing defined phyllosilcates to be mixed with the coated iron-based powder shall be between 0.2-5%, preferably between 0.5-4%, by weight of the coated composite iron-based powder.

The amount of alkaline silicate calculated as solid alkaline silicate to be mixed with the coated iron-based powder shall be between 0.1-0.9% by weight of the coated composite iron-based powder, preferably between 0.2-0.8% by weight of the iron-based powder. It has been shown that various types of water soluble alkaline silicates can be used, thus sodium, potassium and lithium silicate can be used. Commonly an alkaline water soluble silicate is characterised by its ratio, i.e. amount of SiO₂ divided by amount of Na₂O, K₂O or Li₂O as applicable, either as molar or weight ratio. The molar ratio of the water soluble alkaline silicate shall be 1.5-4, both end points included. If the molar ratio is below 1.5 the solution becomes too alkaline, if the molar ratio is above 4 SiO₂ will precipitate.

It may be possible to omit the second kaolin-sodium silicate coating on the amorphous and/or nano-crystalline particles and still achieve excellent magnetic properties. However, in order to further enhance the magnetic properties the second coating layer should cover both the amorphous and/or nano-crystalline particles and the iron powder.

In an alternative embodiment, the alkaline silicate (or clay) coating may be replaced by a metal-organic coating (second coating)

In this case, at least one metal-organic layer is located outside the first phosphorous-based layer. The metal-organic layer is of a metal-organic compound having the general formula:

R₁[(R₁)ₓ(R₂)_{y}(M)]ₙOₙ₋₁R₁

wherein:

M is a central atom selected from Si, Ti, Al, or Zr;

O is oxygen;

R₁ is a hydrolysable group;

R₂ is an organic moiety and wherein at least one R₂ contains at least one amino group;

wherein n is the number of repeatable units and n=1-20; wherein the x may be 0 or 1; wherein y may be 1 or 2;

The metal-organic compound may be selected from the following groups: surface modifiers, coupling agents, or cross-linking agents.

R₁ in the metal-organic compound may be an alkoxy-group having less than 4, preferably less than 3 carbon atoms.

R₂ is an organic moiety, which means that the R₂-group contains an organic part or portion. R₂ may include 1-6, preferably 1-3 carbon atoms. R₂ may further include one or more hetero atoms selected from the group consisting of N, O, S and P. The R₂ group may be linear, branched, cyclic, or aromatic.

R₂ may include one or more of the following functional groups: amine, diamine, amide, imide, epoxy, hydroxyl, ethylene oxide, ureido, urethane, isocyanato, acrylate, glyceryl acrylate, benzyl-amino, vinyl-benzyl-amino. The R₂ group may alter between any of the mentioned functional R₂-groups and a hydrophobic alkyl group with repeatable units.

The metal-organic compound may be selected from derivates, intermediates or oligomers of silanes, siloxanes and silsesquioxanes or the corresponding titanates, aluminates or zirconates.

According to one embodiment at least one metal-organic compound in one metal-organic layer is a monomer (n=1).

According to another embodiment at least one metal-organic compound in one metal-organic layer is an oligomer (n=2-20).

According to another embodiment the metal-organic layer located outside the first layer is of a monomer of the metal-organic compound and wherein the outermost metal-organic layer is of an oligomer of the metal-organic compound. The chemical functionality of the monomer and the oligomer is necessary not same. The ratio by weight of the layer of the monomer of the metal-organic compound and the layer of the oligomer of the metal-organic compound may be between 1:0 and 1:2, preferably between 2:1-1:2.

If the metal-organic compound is a monomer it may be selected from the group of trialkoxy and dialkoxy silanes, titanates, aluminates, or zirconates. The monomer of the metal-organic compound may thus be selected from 3-aminopropyl-trimethoxysilane, 3-aminopropyl-triethoxysilane, 3-aminopropyl-methyl-diethoxysilane, N-aminoethyl-3-aminopropyl-trimethoxysilane, N-aminoethyl-3-aminopropyl-methyl-dimethoxysilane, 1,7-bis(triethoxysilyI)-4-azaheptan, triamino-functional propyl-trimethoxysilane, 3-ureidopropyl-triethoxysilane, 3-isocyanatopropyl-triethoxysilane, tris(3-trimethoxysilylpropyl)-isocyanurate, 0-(propargyloxy)-N-(triethoxysilylpropyI)-urethane, 1-aminomethyl-triethoxysilane, 1-aminoethyl-methyl-dimethoxysilane, or mixtures thereof.

An oligomer of the metal-organic compound may be selected from alkoxy-terminated alkyl-alkoxy-oligomers of silanes, titantes, aluminates, or zirconates. The oligomer of the metal-organic compound may thus be selected from methoxy, ethoxy or acetoxy-terminated amino-silsesquioxanes, amino-siloxanes, oligomeric 3-aminopropyl-methoxy-silane,

3-aminopropyl/propyl-alkoxy-silanes, N-aminoethyl-3-aminopropyl-alkoxy-silanes, or N-aminoethyl-3-aminopropyl/methyl-alkoxy-silanes or mixtures thereof.

The total amount of metal-organic compound may be 0.05-0.6%, preferably 0.05-0.5%, more preferably 0.1-0.4%, and most preferably 0.2-0.3% by weight of the composition. These kinds of metal-organic compounds may be commercially obtained from companies, such as Evonik Ind., Wacker Chemie AG, Dow Corning, etc.

The metal-organic compound has an alkaline character and may also include coupling properties i.e. a so called coupling agent which will couple to the first inorganic layer of the iron-based powder. The substance should neutralise the excess acids and acidic bi-products from the first layer. If coupling agents from the group of aminoalkyl alkoxy-silanes, -titanates, -aluminates, or -zirconates are used, the substance will hydrolyse and partly polymerise (some of the alkoxy groups will be hydrolysed with the formation of alcohol accordingly). The coupling or cross-linking properties of the metal-organic compounds is also believed to couple to the metallic or semi-metallic particulate compound which may improve the mechanical stability of the compacted composite component.

### Metal or Semi-Metallic Particulate Compound

The coated soft magnetic iron-based powder may also contain at least one metallic or semi-metallic particulate compound. The metallic or semi-metallic particulate compound should be soft, having Mohs hardness less than 3.5, and constitute fine particles or colloids. The compound may preferably have an average particle size below 5 μm, preferably below 3 μm, and most preferably below 1 μm. The metallic or semi-metallic particulate compound may have a purity of more than 95%, preferably more than 98%, and most preferably more than 99% by weight. The Mohs hardness of the metallic or semi-metallic particulate compound is preferably 3 or less, more preferably 2.5 or less. SiO₂, Al₂O₃, MgO, and TiO₂ are abrasive and have a Mohs hardness well above 3.5 and is not within the scope of the invention. Abrasive compounds, even as nano-sized particles, cause irreversible damages to the electrically insulating coating giving poor ejection and worse magnetic and/or mechanical properties of the heat-treated component.

The metallic or semi-metallic particulate compound may be at least one selected from the group: lead, indium, bismuth, selenium, boron, molybdenum, manganese, tungsten, vanadium, antimony, tin, zinc, cerium.

The metallic or semi-metallic particulate compound may be an oxide, hydroxide, hydrate, carbonate, phosphate, fluorite, sulphide, sulphate, sulphite, oxychloride, or a mixture thereof.

According to a preferred embodiment the metallic or semi-metallic particulate compound is bismuth, or more preferably bismuth (III) oxide. The metallic or semi-metallic particulate compound may be mixed with a second compound selected from alkaline or alkaline earth metals, wherein the compound may be carbonates, preferably carbonates of calcium, strontium, barium, lithium, potassium or sodium.

The metallic or semi-metallic particulate compound or compound mixture may be present in an amount of 0.05-0.5%, preferably 0.1-0.4%, and most preferably 0.15-0.3% by weight of the composition.

The metallic or semi-metallic particulate compound is adhered to at least one metal-organic layer. In one embodiment of the invention the metallic or semi-metallic particulate compound is adhered to the outermost metal-organic layer.

The metal-organic layer may be formed by mixing the powder by stirring with different amounts of first a basic aminoalkyl-alkoxy silane (Dynasylan®Ameo) and thereafter with an oligomer of an aminoalkyl/alkyl-alkoxy silane (Dynasylan®1146), e.g. by using a 1:1 relation, both produced by Evonik Inc. The composition may be further mixed with different amounts of a fine powder of bismuth(III) oxide (>99 wt %; D₅₀˜0.3 μm).

This good saturation flux density achieved by the material according to the invention makes it possible to downsize inductor components and still maintain good magnetic properties.

### Compaction and Heat Treatment

Before compaction the coated iron-based composition may be mixed with a suitable organic lubricant such as a wax, an oligomer or a polymer, a fatty acid based derivate or combinations thereof. Examples of suitable lubricants are EBS, i.e. ethylene bisstearamide, Kenolube® available from Höganäs AB, Sweden, metal stearates such as zinc stearate or fatty acids or other derivates thereof. The lubricant may be added in an amount of 0.05-1.5% of the total mixture, preferably between 0.1-1.2% by weight.

Compaction may be performed at a compaction pressure of 400-1200 MPa at ambient or elevated temperature.

After compaction, the compacted components are subjected to heat treatment at a temperature up to 700° C., preferably between 500-650° C. Examples of suitable atmospheres at heat treatment are inert atmosphere such as nitrogen or argon or oxidizing atmospheres such as air.

The powder magnetic core of the present invention is obtained by pressure forming an iron-based magnetic powder covered with an electrically insulating coating. The core may be characterized by low total losses in the frequency range 2-100 kHz, normally 5-100 kHz, of about less than 10 W/kg at a frequency of 20 kHz and induction of 0.05 T. Further a resistivity, ρ, more than 1000, preferably more than 2000 and most preferably more than 3000 μΩm, and a saturation magnetic flux density Bs above 1.0, or preferably 1.1, preferably above 1.2 and most preferably above 1.3 T. Further, the coercivity shall be below 200 A/m, preferably below 190 A/m, most preferably below 180 A/m and DC-bias not less than 50% at 4000 A/m.

### EXAMPLES

The following examples are intended to illustrate particular embodiments and should not be construed as a limitation of the scope of the invention.

### Example 1

Nano-crystalline particles from ground tempered melt spun ribbons (thickness 20 μm) with composition (in atomic percent) 73.5% Fe, 15.5% Si, 7% B, 3% Nb, 1% Cu were prepared. Particles were sieved through a 200 mesh sieve. The fraction retained on the sieve was discarded. The nano-crystalline particles were treated with a phosphorous containing solution according to WO2008/069749. Briefly, the coating solution was prepared by dissolving 20 ml of 85% weight of phosphoric acid in 1000 ml of acetone, and 30 ml of acetone solution was used per 1000 g powder. After mixing the phosphoric acid solution with the metal powder, the mixture was allowed to dry. In the following examples this coating is noted as Type 1.

### Example 2

Samples of 1 kg of a 200 mesh water atomized iron powder which has an iron content above 99.5% by weight, was used as core particles for base powder. The mean particle size was about 45 μm as determined by sieve analysis. The core particles were treated with a phosphorous containing solution according to WO2008/069749. Briefly, the coating solution was prepared by dissolving 20 ml of 85% weight of phosphoric acid in 1 000 ml of acetone, and 30 ml of acetone solution was used per 1000 gram of powder. After mixing the phosphoric acid solution with the metal powder, the mixture was allowed to dry. In the following examples this coating is noted as Type 1.

### Example 3

The obtained dry phosphorous coated iron powder (from Example 1) or amorphous powder (from Example 2) were further blended with kaolin and sodium silicate in appropriate amounts, and dried at 120° C. until dryness. In the following examples this coating is noted as Type 2.

### Example 4

The obtained dry phosphorous coated iron powder (Example 1) or nano-crystalline powder (Example 2) were further blended with a second (metal organic) coating layer as described in WO2009/116938, namely mixing the powder by stirring with different amounts of first a basic aminoalkyl-alkoxy silane (Dynasylan®Ameo) and thereafter with an oligomer of an aminoalkyl/alkyl-alkoxy silane (Dynasylan®1146), using a 1:1 relation, both produced by Evonik Inc. The composition was further mixed with different amounts of a fine powder of bismuth(III) oxide (>99wt %; D₅₀˜0.3 μm). In the following examples this coating is noted as Type 3.

### Example 5

The resulting powders from the previous examples were mixed with lubricants, in various combinations. Amounts are shown in Table 1.

| | Nano-crystalline additive | | | Fe-powder | | | |
|---|---|---|---|---|---|---|---|
| Powder mixture | Type 1 | Type 2 | Type 3 | Type 1 | Type 2 | Type 3 | Lubricant |
| A | None | | | X | X(1) | | 0.6% Kenolube |
| B | X(3) | | | X | X(1) | | 0.6% Kenolube |
| C | X(3) | X(1)(3) | | X | X(1) | | 0.6% Kenolube |
| D | None | | | X | X(2) | | 0.6% Kenolube |
| E | X(3) | | | X | X(2) | | 0.6% Kenolube |
| F | X(3) | X(2)(3) | | X | X(2) | | 0.6% Kenolube |
| G | None | | | X | | X | 0.4% Amidewax |
| H | X(3) | | | X | | X | 0.4% Amidewax |
| I | X(3) | | X(3) | X | | X | 0.4% Amidewax |
| J | X(4) | | | X | | X | 0.4% Amidewax |
| K | X(4) | | X(4) | X | | X | 0.4% Amidewax |

(1)2% kaolin and 0.4% sodium silicate
(2)1% kaolin and 0.4% sodium silicate
(3)30% nano-crystalline additive
(4)20% nano-crystalline additive

### Example 6

The resulting mixtures from Example 5 were compacted at 800 MPa or 1100 MPa into rings with an inner diameter of 45 mm, an outer diameter of 55 mm and a height of 5 mm. The compacted components were thereafter subjected to a heat treatment process at 650° C. in a nitrogen atmosphere for 30 minutes.

### Example 7

The specific resistivity of the obtained samples were measured by a four point measurement. For maximum permeability, μₘₐₓ, and coercivity measurements, the rings were “wired” with 100 turns for the primary circuit and 100 turns for the secondary circuit enabling measurements of magnetic properties with the aid of a hysteresisgraph, Brockhaus MPG 200. For core loss the rings were “wired” with 100 turns for the primary circuit and 30 turns for the secondary circuit with the aid of Walker Scientific Inc. AMH-401 POD instrument.

In order to show the effect of using atomized iron together with nano-crystalline particles, the impact of a phosphorous coating layer and the impact of a kaolin and sodium silicate or a metal-organic second coating of the iron-powder on the properties of the compacted and heat treated component, samples 1-16 were prepared according to Table 2 which also shows results from testing of the components.

TABLE 2

| | | Component properties | | | | |
|---|---|---|---|---|---|---|
| | | Resistivity | | Coercivity | Core loss at 0.05T | |
| Sample | Powder mixture | [μΩ · m] | μmax [—] | [A/m] | 20 kHz [W/kg] | B_{@10 kA/m} [T] |
| | 100% iron powder (Type1 + 2), 800 MPa | | | | | |
| 1 | A | 800000 | 73 | 221 | 14.9 | 0.75 |
| | 30% nano-crystalline additive (Type 1) + 70% iron powder (Type 1 + 2), 800 MPa | | | | | |
| 2 | B | 100000 | 58 | 138 | 9.2 | 0.56 |
| | 30% nano-crystalline additive (Type 1 + 2) + 70% iron powder (Type 1 + 2), 800 MPa | | | | | |
| 3 | C | | | | | |
| | 100% iron powder (Type1 + 2), 800 MPa | | | | | |
| 4 | D | 100000 | 97 | 225 | 13.5 | 0.91 |
| | 30% nano-crystalline additive (Type 1) + 70% iron powder (Type 1 + 2), 800 MPa | | | | | |
| 5 | E | 50000 | 60 | 138 | 8.8 | 0.58 |
| | 30% nano-crystalline additive (Type 1 + 2) + 70% iron powder (Type 1 + 2), 800 MPa | | | | | |
| 6 | F | | | | | |
| | 100% iron powder (Type1 + 3), 800 MPa | | | | | |
| 7 | G | 50000 | 192 | 225 | 10.1 | 1.29 |
| | 100% iron powder (Type1 + 3), 1100 MPa | | | | | |
| 8 | G | 50000 | 193 | 223 | 9.2 | 1.32 |
| | 30% nano-crystalline additive (Type 1) + 70% iron powder (Type 1 + 3), 800 MPa | | | | | |
| 9 | H | 45000 | 79 | 169 | 7.6 | 0.68 |
| | 30% nano-crystalline additive (Type 1) + 70% iron powder (Type 1 + 3), 1100 MPa | | | | | |
| 10 | H | 45000 | 96 | 161 | 6.9 | 0.77 |
| | 30% nano-crystalline additive (Type 1 + 3) + 70% iron powder (Type 1 + 3), 800 MPa | | | | | |
| 11 | I | | | | | |
| | 30% nano-crystalline additive (Type 1 + 3) + 70% iron powder (Type 1 + 3), 1100 MPa | | | | | |
| 12 | I | | | | | |
| | 20% nano-crystalline additive (Type 1) + 80% iron powder (Type 1 + 3), 800 MPa | | | | | |
| 13 | J | 60000 | 79 | 190 | 7.8 | 0.71 |
| | 20% nano-crystalline additive (Type 1) + 80% iron powder (Type 1 + 3), 1100 MPa | | | | | |
| 14 | J | 60000 | 91 | 189 | 7.2 | 0.80 |

| | 20% nano-crystalline additive (Type 1 + 3) + 80% iron powder (Type 1 + 3), 800 MPa |
|---|---|
| 15 | K |
| | 20% nano-crystalline additive (Type 1 + 3) + 80% iron powder (Type 1 + 3), 1100 MPa |
| 16 | K |

As can be seen from Table 2, the combination of atomized iron and nano-crystalline particles considerably lowers coercivity and core losses for all combinations of above.

1. A mixture of atomized iron particles and iron based amorphous and/or nano-crystalline particles, wherein the particles are coated with a first phosphorous containing layer.

2. Mixture according to claim 1, wherein the atomized iron particles, and optionally the iron based amorphous and/or nano-crystalline particles, have a second layer comprising:
(a) an alkaline silicate combined with a clay mineral containing a phyllosilicate, the combined silicon-oxygen tetrahedral layer and hydroxide octahedral layers thereof being electrical neutral, or;
(b) a metal-organic layer.

3. Mixture according to claim 2, wherein the iron based amorphous and/or nano-crystalline particles and the atomized iron particles have been covered by either:
(a) the alkaline silicate combined with a clay mineral containing a phyllosilicate, the combined silicon-oxygen tetrahedral layer and hydroxide octahedral layers thereof being electrical neutral, or;
(b) the metal organic layer.

4. Mixture according to claim 2, wherein layer (a) comprises kaolin and sodium silicate.

5. A soft magnetic component manufactured by compacting the mixture according to claim 1.
